(19) United States
(12) Patent Application Publication
(10) Pub. No.: US 2005/0269877 A1
(43) Pub. Date: Dec. 8, 2005

(54) Device to reduce the accumulation of snow and other debris in the wheels of tracked vehicles

(76) Inventors: Remi Breton, St-Charles-de-Drummond (CA); Louis-James Verville, St-Nicephore (CA)

Correspondence Address: Robert Brouillette;BROUILLETTE & PARTNERS, 23RD Floor, 1100 Rene-Levesque Boulevard West, Montreal, QC, H3B 4N4, CA

(21) Appl. No.: 11/142,697

(22) Filed: Jun. 2, 2005

(30) Foreign Application Priority Data
Jun. 9, 2004 (CA) 2,470,553
Apr. 11, 2004 (CA) 2,504,051

(51) Int. Cl. B60S 1/62

(52) U.S. Cl. 305/107

(57) ABSTRACT

This invention relates to a device to reduce and preferably avoid the accumulation of snow, ice, mud, soil and other debris in the idler and/or sprocket wheels of tracked vehicles. The device comprises a support adjustably associated with the tracked vehicle and having a fastening located about the track wheel, a band having a connecting part customized to be adjustably secured by the fastening into position about the track wheel and a collar part freely extending from the connecting part and at least partially embracing the wheel for remaining in a constant slipping contact or near contact with at least part of the wheel to reduce the packing of snow, ice, mud, soil or other debris in the idler and/or sprocket wheels.

### FIELD OF THE INVENTION

The present invention relates to track type vehicles, and more specifically to a device to reduce the accumulation of snow, ice, mud, soil and other debris in the idler and/or sprocket wheels of tracked vehicles during driving operations.

### BACKGROUND OF THE INVENTION

Conventionally, track type vehicles comprise a set of wheels on each side of the vehicle that run in a track. During the operation, the track picks up materials such as snow, ice, mud, soil and other debris from the ground and carries them into the wheel where they often become packed between the inner surface of the track and the wheel. In the case of rubber tracks, this can result in de-tracking of the track from the wheels.

There exist some devices to scrape the mud from the wheels of tracked vehicles.

U.S. Pat. No. 5,226,703 issued to Norman on Jul. 13, 1993 disclosed an idler roller mounting/scraper for track vehicle which includes mounting bracket with two sets of teeth on opposite sides of the roller in order to scrape and remove mud and debris. While this device may be suitable for the particular purpose which it addresses, the design of this device is very complex.

U.S. Pat. No. 5,725,292 issued to Keedy et al on May 10, 1998 disclosed a scraping apparatus for a track idler which provides a scraper assembly that defines a plurality of scraping portions that continuously engage the contact surfaces of the idler to remove foreign material from there before the contact surfaces engage other track chain components. While this design may be operated with some success, this design is subject to severe wear.

U.S. Pat. No. 5,697,683 issued to Arulandu et al. on Dec. 16, 1997 disclosed a Biased scraping apparatus for an idler which provides a scrapper assembly that defines a plurality of scraping portions that are adapted to carry a scraping insert on an end portion thereof. While this device may be suitable for the particular purpose which it addresses, the design of this device is relatively intricate and significantly costly.

U.S. Pat. No. 6,019,443 issued to Freeman on Feb. 1, 2000 disclosed a debris cutter for sprocket drive which has stationary cutter blades fixed to a chassis of the tractor to cut refuse entrained between the sprocket and the chassis. While this device may be suitable for the particular purpose to which it addresses, it is operative only during one-way rotation of the wheel.

It is more effective to prevent or reduce the accumulation of snow, ice, mud, soil and other debris in the track wheels instead of having to scrape and remove the snow, ice, mud, soil and debris later. Thus, there is a need to develop a device to reduce the accumulation of snow, ice, mud, soil and other debris in the track wheels of tracked vehicles rather than to remove it once it has so accumulated. Furthermore, there is a need for such an apparatus that applies very little pressure on the wheels in contrast to existing scraper solutions.

### OBJECTS OF THE INVENTION

Accordingly, an object of the present invention is to provide a device to reduce the accumulation of snow, ice, mud, soil and other debris in the idler and/or sprocket wheels of tracked vehicles that obviates the above-mentioned disadvantages.

A further object of the present invention is to provide a device to reduce the accumulation of snow, ice, mud, soil and other debris in the idler and/or sprocket wheels of tracked vehicles which is effectively operative regardless of the direction of wheel rotation.

One more object of the present invention is to provide a device to reduce the accumulation of snow, ice, mud, soil and other debris in the idler and/or sprocket wheels of tracked vehicles which requires less maintenance.

Still a further object of the present invention is to provide a device to reduce the accumulation of snow, ice, mud, soil and other debris in the idler and/or sprocket wheels of tracked vehicles which is easy to manufacture.

Another object of the present invention is to provide a device to reduce the accumulation of snow, ice, mud, soil and other debris in the idler and/or sprocket wheels of tracked vehicles which is inexpensive.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

To attain these and other objects which will become more apparent as the description proceeds according to one aspect of the present invention, there is provided a device to reduce the accumulation of snow, ice, mud, soil and other debris in the sprocket and/or idler wheels of tracked vehicles.

Such wheels are often made in two parts: an outer wheel and an inner wheel. These wheels are joined near the axel opening and are separated near their outer perimeter such that they may receive the guide lugs or horns located on the inner surface of the track.

A first embodiment of the invention comprises a support being adjustably associated with the tracked vehicle and having fastening means located near the idler and/or sprocket wheels, a band having a connecting part customized to be adjustably secured by the fastening into position about the wheel and a collar part freely extending from the connecting part and at least partially embracing the wheel hub for remaining in a constant slipping contact or near contact with at least part of the interior of the wheel to reduce the accumulation of snow, ice, mud, soil and other debris on the idler and/or sprocket wheels during a driving condition of the tracked vehicle. Preferably, the band is made from a resilient material such as spring steel or reinforced rubber.

A second embodiment of the device to reduce the accumulation of snow, ice, mud, soil and other debris in the sprocket and/or idler wheels of tracked vehicles comprises a support being adjustably associated with the tracked vehicle and having fastening means located near the track wheel, a band having a connecting part customized to be adjustably secured by the fastening means into position about the track wheel, a collar part at least partially embracing the wheel to remain in a constant slipping contact or near contact with at least part of the interior of the wheel to reduce the accumulation of snow, ice, mud, soil and other debris in the idler and/or sprocket wheels during a driving condition of the tracked vehicle, and a linking part adjustably linking the collar part to the connecting part.

It is preferable that the collar has a contact surface generally matching the configuration of the track receiving internal surface of the wheel.

Preferably, the collar has at least one slipper which is inwardly projected toward the track wheel to be in a constant slipping contact or near contact with the same. And also, it is preferable that at least the interior of the collar be made from a low friction material such as UHMW polyethylene.

Preferably, the connecting part is made from a resilient material. It is also preferable that the collar is made from a resilient material such as spring steel or rubber with wire or other reinforcing inserts.

### BRIEF DESCRIPTION OF THE DRAWINGS

For a fuller understanding of the nature and object of the invention, reference should be had to the following detailed description taken in connection with the accompanying drawings in which:

FIG. 1 is a fragmentary isometric side view of one of the embodiments of the device to reduce the accumulation of snow, ice, mud, soil and other debris in the track wheels of tracked vehicles, according to the present invention, in working position around an idler wheel; and

FIG. 2 is an isometric side view of another embodiment of the device to reduce the accumulation of snow, ice, mud, soil and other debris in the wheels of tracked vehicles.

FIG. 3 is a cross-sectional view of the device and wheel shown in FIG. 1 also showing the track.

### DETAILED DESCRIPTION OF THE PREFERRED EMBODIMENTS

With reference to the annexed drawings, the preferred embodiments of the present invention will be herein described for indicative purposes and by no means as of limitation.

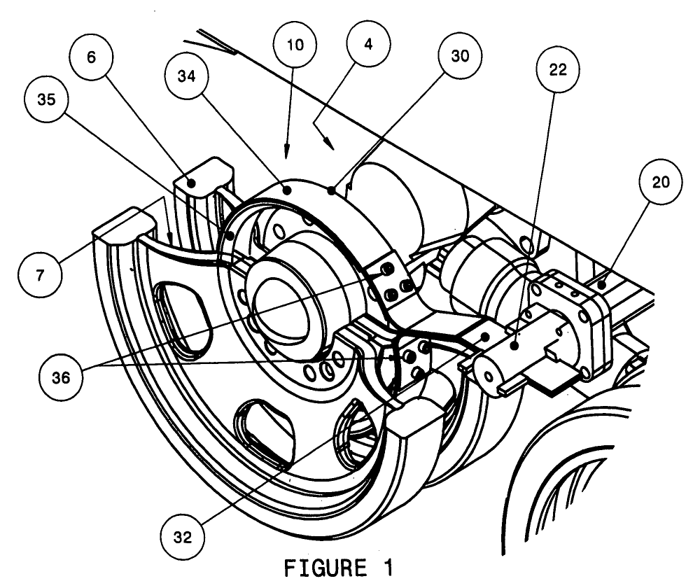

FIG. 1 shows a device 10 to reduce the accumulation of snow, ice, mud, soil and other debris in the idler wheel of a tracked vehicle as installed.

The device 10 includes an attachment portion 32′ and a band portion 30′. A support 20 is adjustably associated with the tracked vehicle 4 and is provided with holding means 22 located near the idler wheel 6.

The band portion 30′ and the attachment portion 32′ are preferably made from a resilient material.

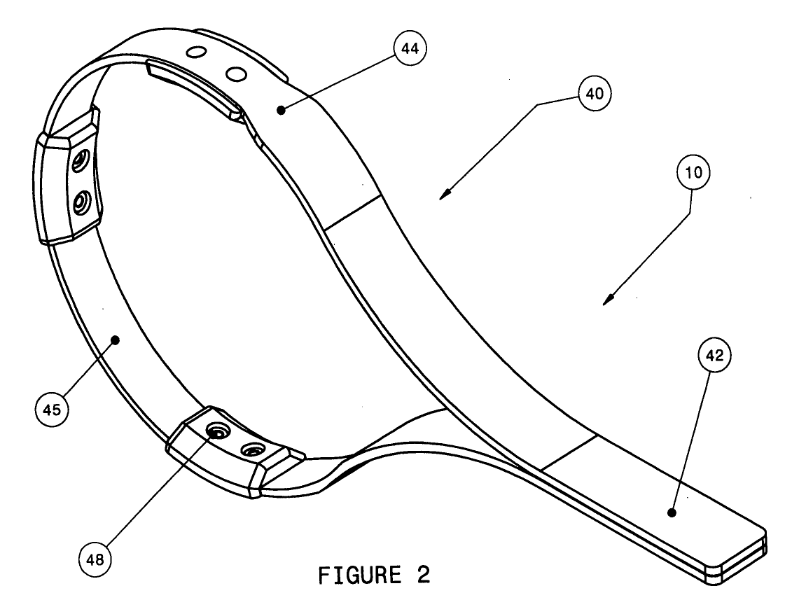

In FIG. 1 the band portion 30′ is made of spring steel. while the band portion 30 shown in FIG. 2 is made of reinforced rubber.

As seen in FIG. 1, the attachment portion 32′ is customized to be adjustably secured near the idler wheel by the holding mean 22. The band portion 30′ freely extends from the attachment portion 32′ and at least partially embraces said wheel for remaining in a constant slipping contact or near contact with at least part of the track wheel 6 to reduce the accumulation of snow, ice, mud, soil and other debris on the wheels 6 during a driving condition of the tracked vehicle 4. The band portion 30′ is fixed to the attachment portion 32′ by bolt 36 or other known means.

FIG. 2 illustrates a second embodiment of the device 10 which allows to reduce the accumulation of snow, ice, mud, soil and other debris in the track wheels of tracked vehicles. In the second embodiment of the device 10 the band portion 30 is integral with the attachment portion 32 and is made of reinforced rubber.

In accordance with the invention, the band portion 30 has an internal surface 35 generally matching the configuration of the interior portions 7 and 8 of the wheel 6 and an external surface 34 on which snow, ice, mud, soil or other debris may accumulate. In FIG. 2 the internal surface 35 is discontinuous and is made of a plurality of slipper segments 38. The slipper segments 38 are preferably made from a low friction material such as UHMW polyethylene. On the other hand, it is preferable that a minimum amount of friction be present between the internal surfaces 7 and 8 of wheel 6 and any snow, ice, mud, soil or other debris which may become lodged between the track, the internal surfaces 7 and 8 and the external surface 34 such that such snow, ice, mud, soil or other debris be dislodged as a result of the relative movement of such snow, ice or other debris in relation to the attachment portion 32.

As is well understood, the internal surface 35 and the slipper elements 38 may assume a variety of forms, lengths and cross-sectional profiles (not shown) as long as they are complementary with the configuration of the internal surfaces 7 and 8 of wheel 6. Also, the device 10 may be made from any suitable material well known in the art.

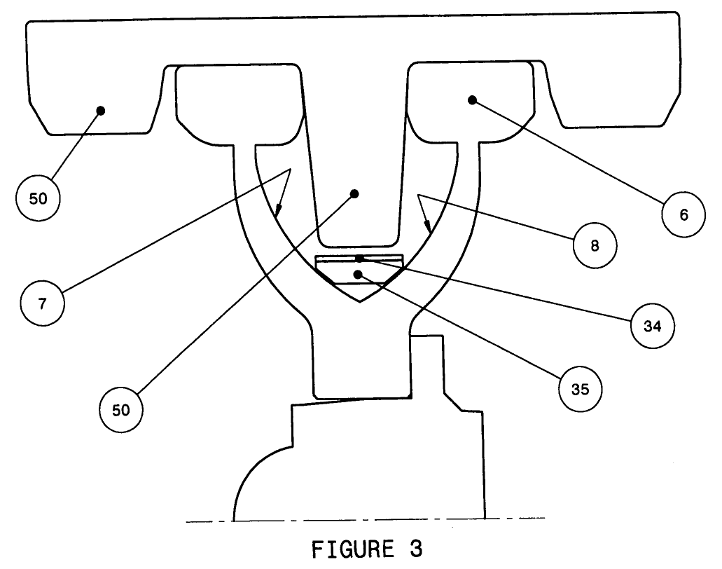

As seen in FIG. 3, during normal operation of the vehicle, especially when operating a turn, snow, ice, mud, soil or other debris is introduced in the space between the track 50, the internal wheel surfaces 7 and 8 and the external band surface 34. As the wheel 6 turns (either clockwise or counterclockwise), this snow, ice, mud, soil or other debris is entrained by the friction between it and the track 50 and the internal wheel surfaces 7 and 8. It slides over external surface 34 until it reaches the attachment portion 32 (or 32′) where it is forcefully expelled.

During any driving condition when the track vehicle 4 is moving forward, backwards or doing any maneuvers when the track wheel 6 rotates, the band portion 30 (or 30′) of the device 10 effectively presents (or prevents?) any significant accumulation of snow, ice, mud, soil or other debris from between the internal surfaces 7 and 8 of wheel 6 and the track 50. Device 10 is bi-directional in the sense that it works effectively in either direction of track wheel rotation, and is extremely simple in design and effective in operation.

The drawings and the description attached to it are only intended to illustrate the idea of the invention. As to the details, the invention may vary within the scope of the claims. So, the shape of the device 10 may be formed as desired, considering the needs and specific track wheel 6 models.

Although the present device to reduce the accumulation of snow, ice, mud, soil and other debris in the wheels of tracked vehicles has been described with a certain degree of particularity, it is to be understood that the disclosure has been made by way of example only and that the present invention is not limited to the features of the embodiment(s) described and illustrated herein, but includes all variations and modifications within the scope and spirit of the invention as hereinafter claimed.

1. A device to reduce the accumulation of snow, ice, mud, soil and other debris in a wheel of tracked vehicles of the type having an inside wheel portion and an outside wheel portion defining an open space there between, comprising:
a support being adjustably attached to said tracked vehicle and having fastening means located near said space,
a band customized to be adjustably secured by said fastening means into position around said wheel within said space.

2. A device as claimed in claim 1 wherein said wheel is an idler wheel and/or a sprocket wheel.

3. A device as claimed in claim 2 wherein said band is made of a resilient material.

4. A device as claimed in claim 3 wherein said band is made of reinforced rubber.

5. A device as claimed in claim 3 wherein said band is made of spring steel.

6. A device to reduce the accumulation of snow, ice, mud, soil and other debris in the wheels of tracked vehicles, comprising:
a support being adjustably attached to said tracked vehicle and having fastening means located near said track wheel,
a band having a connecting part customized to be adjustably secured by said fastening means into position near the wheel, a collar part at least partially embracing the interior of said wheel to remain in a constant slipping contact or in near contact with at least part of said wheel interior to reduce the accumulation of said snow, ice, mud, soil and other debris in the wheels during the operation of the tracked vehicle, and a linking part adjustably linking the collar part to the connecting part.

7. The device according to claim 6, wherein the collar has a contact surface generally matching a track lug-receiving surface of the wheel.

8. The device according to any one of claims 6 or 7, wherein the collar has at least one slipper which is inwardly projected towards the track wheel to be in a constant slipping contact or in near contact with the same.

9. The device according to any one of claims 6 to 8, wherein the collar is made from a low friction material.

10. The device according to claim 6, wherein the band is made from a resilient material.

11. The device according to claim 7, wherein the connecting part is made from a resilient material.

12. The device according to any one of claims 7 to 9, wherein the collar is made from a resilient material.
